(19) United States
(12) Patent Application Publication
(10) Pub. No.: US 2025/0381814 A1
(43) Pub. Date: Dec. 18, 2025

(54) SUSPENSION BALL JOINT

(71) Applicant: JASON CO., LTD., PINGTUNG COUNTY (TW)

(72) Inventor: HUNG-YU CHEN, PINGTUNG COUNTY (TW)

(21) Appl. No.: 18/740,767

(22) Filed: Jun. 12, 2024

(51) Int. Cl. B60G 7/00; F16C 11/06

(52) U.S. Cl. CPC B60G 7/005; F16C 11/0628; F16C 11/0642

(57) ABSTRACT

A suspension ball joint includes a base cap, an interior of which accommodates a bearing socket, a ball stud, a restriction unit disposed on a top of the bearing socket, and an elastic unit disposed on a top of the restriction unit. A cover unit is disposed on a top of the elastic unit. The bearing socket is made of metal and tightly engaged with the base cap, thereby increasing the strength and preventing the bearing socket from rubbing against the base cap while operating the ball stud. When the restriction unit, the elastic unit, and the cover unit are sequentially arranged within the interior of the base cap, the concatenation of these units prevents improper pressing forces, thereby preventing the ball stud from rubbing against the bearing socket. Thus, the service life and the durability of the suspension ball joint are improved.

### BACKGROUND OF THE INVENTION

### 1. Field of the Invention

This invention relates to a vehicle suspension component and relates particularly to a suspension ball joint for automotive suspension.

### 2. Description of the Related Art

The suspension ball joint, also known as a spherical universal bearing, is a component using in the vehicle suspension system. The suspension ball joint allows a control arm to be connected to a vehicle body so that the control arm and the vehicle body are free to rotate relative to each other. Thus, the suspension ball joint is the hinge between the vehicle body and the vehicle suspension system.

Referring to FIG. 1, China patent no. CN110352305B discloses a ball joint 1 including a ball stud 11, a base cap 12 adapted to accommodate the ball stud 11, and a cover unit 13 engaged with the base cap 12. The ball stud 11 has a ball portion 111 and a stud portion 112 extending outwards from the ball portion 111. The base cap 12 has a cap body 121, an accommodation space 124 enclosed by the cap body 121, a bearing socket 122 disposed in the accommodation space 124, and a bending portion 123 disposed on a top edge of the cap body 121. The bending portion 123 extends in the direction of the accommodation space 124 so that the ball stud 11 is positioned in the accommodation space 124 and abuts against the bearing socket 122. A surface of the bearing socket 122 contacting the ball portion 111 has a concave shape so that the surface of the bearing socket 122 is brought into sliding abutment with the ball portion 111. The bearing socket 122 is made from a polyoxymethylene material, also known as acetal, polyacetal, and polyformaldehyde.

During the installation of the ball joint 1, the frictional resistance caused when the ball portion 111 and the base cap 12 rub against each other should be controlled within an allowable torque tolerance. If the frictional resistance is too large, it will delay or impede the movement or the installation. If the frictional resistance is too small, the ball portion 111 will be loose, and that shortens the service life of the ball joint 1. Therefore, the ball joint 1 takes an advantage that the bearing socket 122 is made from a polyoxymethylene material to provide certain strength, lubricity and elasticity, thereby achieving a smooth operation of the ball portion 111 within the bearing socket 122 when the ball portion 111 contacts the bearing socket 122.

Because the base cap 12 is made of a metal material and the bearing socket 122 is made from a polyoxymethylene material which is slightly flexible, the bearing socket 122 cannot be engaged with the cap body 121 tightly, and thus the bearing socket 122 will rotate and rub against the cap body 121 while operating the ball portion 111. Therefore, the service life of the bearing socket 122 is shortened caused by the improper friction. Further, the shape of the base cap 12 and the material of the bearing socket 122 are aimed at resisting the pulling forces, not the pressing forces. When the pressing forces caused when the ball portion 111 presses the bearing socket 122 and the base cap 12 are too large, the base cap 12 may be damaged, and that requires to be improved.

Referring to FIG. 2, US patent no. 2020/0003252A1 discloses a ball joint 2 including a ball stud 21, a base cap 22 adapted to accommodate the ball stud 21, a bearing socket 23 disposed in the base cap 22, an elastic unit 24 disposed between the bearing socket 23 and the base cap 22, a restriction unit 25 connected to the base cap 22 and adapted to confine the ball stud 21 within the base cap 22, an engagement unit 26 respectively engaged with the base cap 22 and the restriction unit 25, and a cover unit 27 disposed beside the restriction unit 25. However, the restriction unit 25 is not engaged with the bearing socket 23, and thus the bearing socket 23 will rotate easily and rub against the base cap 22 while operating the ball stud 21. Therefore, the service life of the bearing socket 23 is also shortened caused by the improper friction, and that requires to be improved.

Referring to FIG. 3, US patent no. 9296271B2 discloses a ball joint 3 characterized in that a receiving trough 33 is disposed in a bearing socket 31 and a restriction unit 32 respectively and adapted to accommodate lubricating liquid for the purpose of lubrication. Because the bearing socket 31 is not engaged with the restriction unit 32, an operation of a ball portion 351 of a ball stud 35 will result in the displacement or deviation of the restriction unit 32. Therefore, the restriction unit 32 will rub against the base cap 34, and that shortens the service life of the ball joint 3. Thus, the ball joint 3 also requires to be improved.

### SUMMARY OF THE INVENTION

The object of this invention is to provide a suspension ball joint capable of preventing improper friction effectively, prolonging the service life, and improving the durability.

The suspension ball joint of this invention comprises a ball stud, a bearing socket made of a metal material, a base cap whose interior allows the accommodation of the bearing socket and the ball stud, a restriction unit engaged with the bearing socket, an elastic unit disposed beside the restriction unit, and a cover unit engaged with the base cap. The ball stud has a ball portion and a stud portion connected to the ball portion. The bearing socket has a socket opening and at least one socket trough communicating with the socket opening. The base cap has a cap body whose interior is enclosed by an inner cap wall and a bending portion formed on a top edge of the cap body. A central axis is defined by the interior of the cap body, and the bending portion extends toward the central axis. When the bearing socket is arranged within the interior of the cap body and tightly engaged with the inner cap wall, the interior of the cap body is divided by the arrangement of the bearing socket into a first room adapted to accommodate the ball portion of the ball stud and a second room adapted to accommodate lubricating liquid. The socket opening of the bearing socket respectively communicates with the first room and the second room. The cover unit has a fastening portion situated within the interior of the cap body and a surrounding portion extending outwards from the fastening portion. The stud portion of the ball stud is inserted through the surrounding portion to allow a portion of the stud portion to be exposed outside the surrounding portion. When the fastening portion, the elastic unit, and the restriction unit are sequentially arranged between the stud portion and the bearing socket after the bearing socket and the ball portion of the ball stud are situated within the interior of the cap body, the fastening portion is pressed by and engaged with the bending portion so that the elastic unit and the restriction unit are densely placed in position within the interior of the cap body, thereby allowing the restriction unit to confine the ball portion within the first room and achieving a proper engagement. Because the bearing socket is engaged with the cap body in a tight fit manner, it prevents the bearing socket from being rotated while operating the ball portion, thereby preventing the bearing socket from rubbing against the cap body and preventing improper friction. The elastic unit prevents the restriction unit from being improperly pressed by the fastening portion and the bending portion, thereby reducing the pressing forces applied on the ball portion caused by the restriction unit. Further, the bearing socket is made of a metal material so that the strength is increased. The lubricating liquid accommodated in the second room is adapted for achieving the purpose of lubrication. An engagement unit or an anti-skid gasket is preferably adapted to prevent the displacement or deviation of the restriction unit, thereby preventing the restriction unit from rubbing against the cap body improperly. Thus, the service life and the durability of the suspension ball joint are improved.

Preferably, the suspension ball joint is adapted to be used in a vehicle suspension system.

Preferably, an engagement unit is respectively disposed on the bearing socket and the restriction unit so that the bearing socket is engaged with the restriction unit by the engagement unit.

Preferably, the engagement unit has a first engagement portion disposed on the bearing socket and a second engagement portion disposed on the restriction unit. The first engagement portion is snugly engaged with the second engagement portion.

Preferably, an anti-skid gasket is disposed between the restriction unit and the cap body of the base cap.

### BRIEF DESCRIPTION OF THE DRAWINGS

FIG. 1 is a schematic view showing a conventional ball joint disclosed in China patent no. CN110352305B;

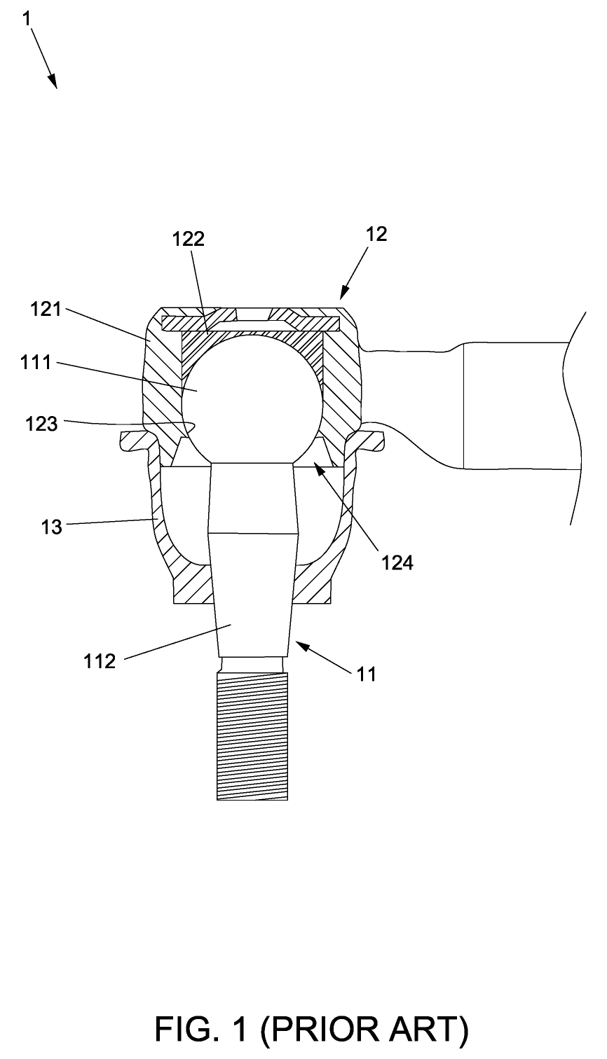

FIG. 2 is a schematic view showing a conventional ball joint disclosed in US patent no. 2020/0003252A1;

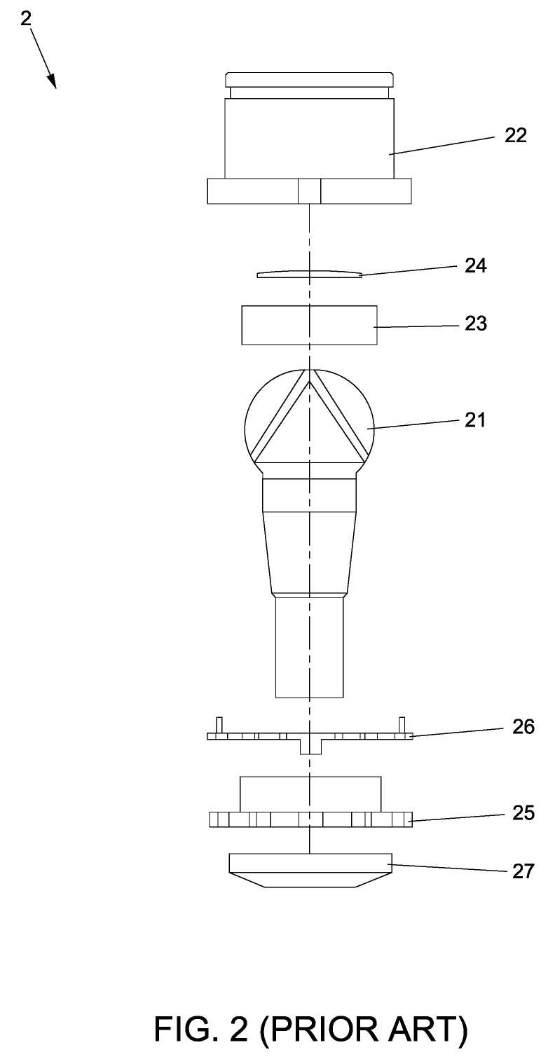

FIG. 3 is a schematic view showing a conventional ball joint disclosed in US patent no. 9296271B2;

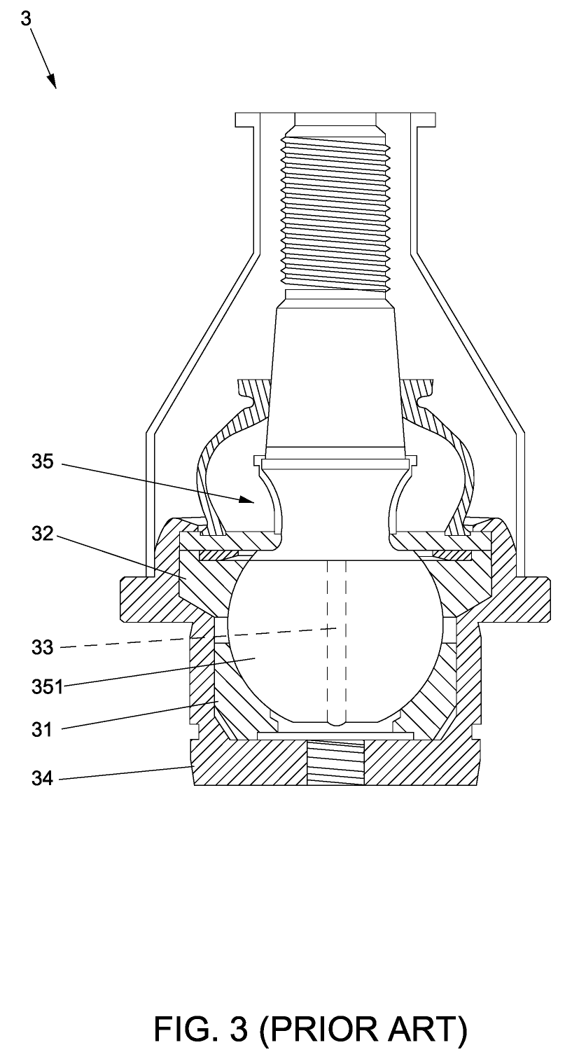

FIG. 4 is an exploded view showing a first preferred embodiment of this invention;

FIG. 5 is a cross-sectional view showing the first preferred embodiment of this invention;

FIG. 6 is a perspective view showing partial elements of the first preferred embodiment of this invention;

FIG. 7 is an exploded view showing a second preferred embodiment of this invention characterized in that an anti-skid gasket is disposed between the bearing socket and the restriction unit;

FIG. 8 is a cross-sectional view showing the second preferred embodiment of this invention; and

FIG. 8A is an enlarged view of the encircled portion 8A indicated in FIG. 8.

### DETAILED DESCRIPTION OF THE PREFERRED EMBODIMENTS

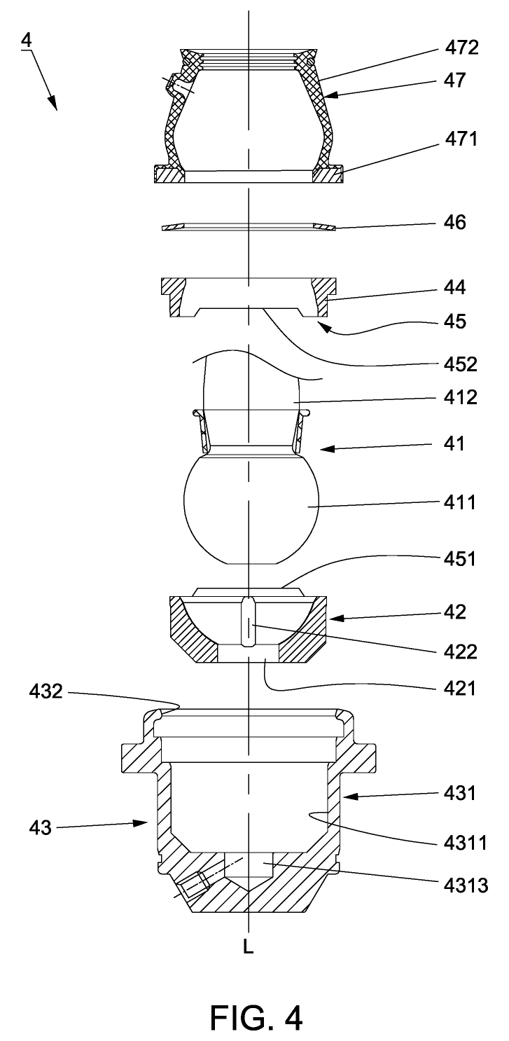

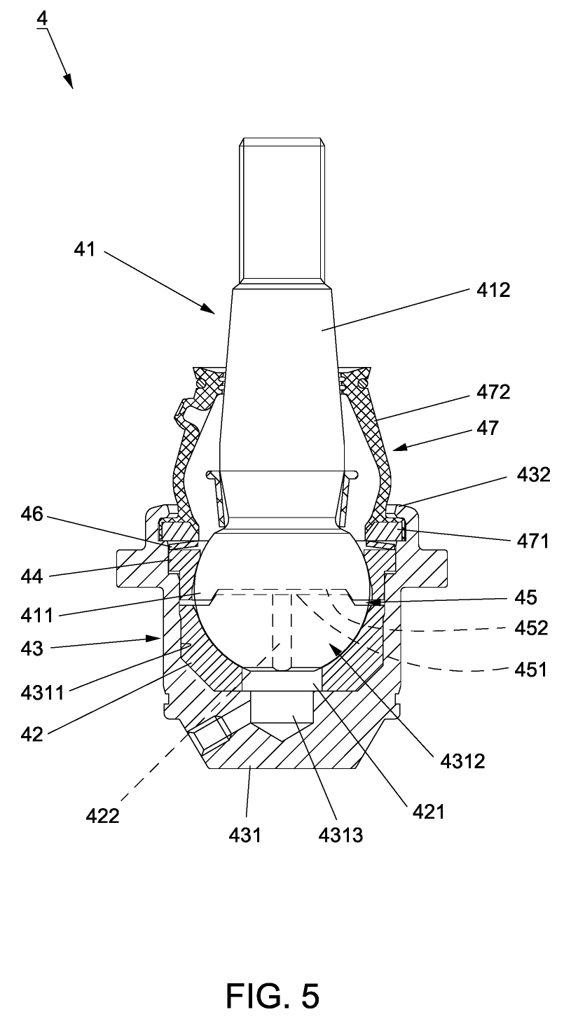

Referring to FIGS. 4 and 5, a first preferred embodiment of a suspension ball joint 4 of this invention is disclosed. The suspension ball joint 4 is adapted to be used in a vehicle suspension system. The suspension ball joint 4 comprises a ball stud 41, a bearing socket 42 made of a metal material, a base cap 43 whose interior is adapted to accommodate the bearing socket 42 and the ball stud 41, a restriction unit 44 connected to the bearing socket 42, an elastic unit 46 installed above the restriction unit 44 and opposite to the bearing socket 42, and a cover unit 47 engaged with the base cap 43 and adapted to accommodate a portion of the ball stud 41. The ball stud 41 includes a ball portion 411 and a stud portion 412 extending outwards from the ball portion 411. The stud portion 412 is adapted to be connected to a component of the vehicle suspension system, such as a control arm, a rack end, or an anti-roll bar.

The bearing socket 42 includes a socket opening 421 and at least one socket trough 422 communicating with the socket opening 421. The base cap 43 includes a cap body 431 whose interior is enclosed by an inner cap wall 4311 and a bending portion 432 installed on a top edge of the cap body 431. The interior of the cap body 431 defines a central axis L. The bending portion 432 extends in the direction of the central axis L. The bearing socket 42 is situated within the interior of the cap body 431 and tightly engaged with the inner cap wall 4311 so that the interior of the cap body 431 is divided by the bearing socket 42 into a first room 4312 and a second room 4313. The first room 4312 is adapted to accommodate the ball portion 411 of the ball stud 41. The second room 4313 is adapted to accommodate lubricating liquid for the purpose of lubrication. The socket opening 421 communicates with the first room 4312 and the second room 4313 respectively. Because the interior of the cap body 431 enclosed by the inner cap wall 4311 is slightly smaller than the volume of the bearing socket 42, the bearing socket 42 will be engaged with the inner cap wall 4311 in a tight compression manner so that the bearing socket 42 is fixed to the cap body 431, thereby preventing the bearing socket 42 from being rotated and preventing the displacement or deviation of the bearing socket 42. Meanwhile, the bearing socket 42 is made of a metal material which is provided without elasticity, and that also facilitates the tight engagement between the bearing socket 42 and the cap body 431. A surface of the bearing socket 42 contacting the ball portion 411 has a shape relative to the shape of the ball portion 411, namely a concave shape, so that the surface of the bearing socket 42 fits and abuts against the ball portion 411. During a manufacturing process of the suspension ball joint 4, the bearing socket 42 and the cap body 431 may be produced into two separate components. The bearing socket 42 is arranged within the interior of the cap body 431 after being produced. Optionally, the bearing socket 42 and the cap body 431 may be produced and integrated into one component. Here takes an example that the bearing socket 42 and the base cap 43 are two separate components.

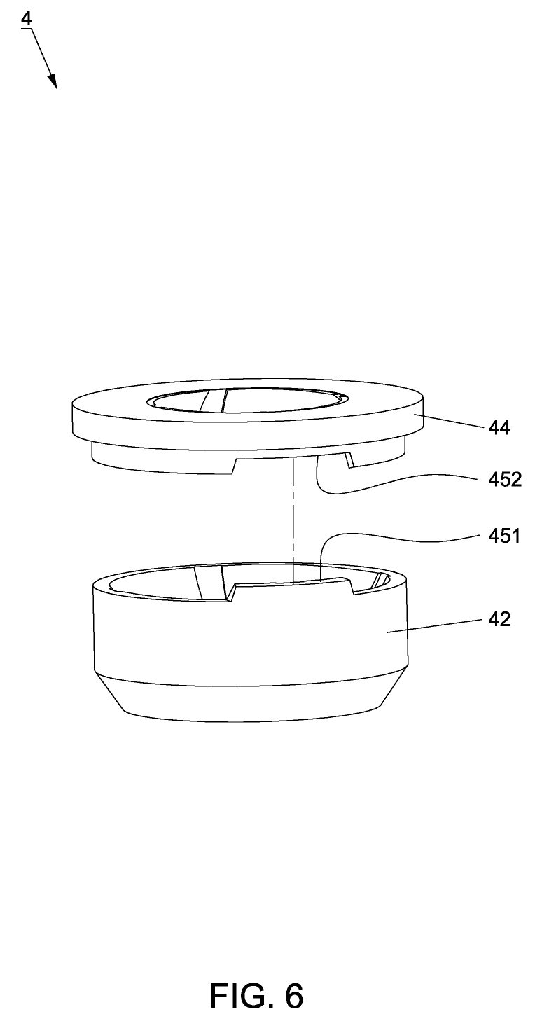

Referring to FIGS. 5 and 6, the restriction unit 44 is disposed within the interior of the cap body 431 and located above the bearing socket 42. The restriction unit 44 is engaged with the bearing socket 42. In this preferred embodiment, the restriction unit 44 and the bearing socket 42 are engaged to each other by an engagement unit 45. The engagement unit 45 includes a first engagement portion 451 installed on the bearing socket 42 and a second engagement portion 452 installed on the restriction unit 44. The first engagement portion 451 is snugly engaged with the second engagement portion 452. The elastic unit 46 is installed within the interior of the cap body 431 and situated above the restriction unit 44. The elastic unit 46 may be a disc spring or a plastic spring according to needs. Here takes an example that the elastic unit 46 is a disc spring as shown in FIGS. 4 and 5. The cover unit 47 includes a fastening portion 471 installed within the interior of the cap body 431 and situated above the elastic unit 46 and a surrounding portion 472 extending outwards from the fastening portion 471. The stud portion 412 of the ball stud 41 extends from the ball portion 411 and penetrates through the surrounding portion 472 to allow a portion of the stud portion 412 to be exposed outside the surrounding portion 472. After the bearing socket 42 is fixed within the interior of the cap body 431, the ball portion 411 of the ball stud 41 is situated within the first room 4312 so that the ball portion 411 abuts against the bearing socket 42. The restriction unit 44 is then situated on a top of the bearing socket 42 and engaged with the bearing socket 42 by the engagement unit 45 so that the ball portion 411 is properly positioned and confined within the first room 4312 by the restriction unit 44. The elastic unit 46 is situated on a top of the restriction unit 44 within the interior of the cap body 431 and opposite to the bearing socket 42. The fastening portion 471 of the cover unit 47 is situated within the interior of the cap body 431 and pressed by the bending portion 432 so that the elastic unit 46 and the restriction unit 44 are densely positioned within the interior of the cap body 431 properly.

Referring to FIGS. 4, 5 and 6, during the installation of the suspension ball joint 4, the bearing socket 42 is situated within the interior of the cap body 431 of the base cap 43 so that the bearing socket 42 is tightly engaged with the inner cap wall 4311, thereby dividing the interior of the cap body 431 into the first room 4312 and the second room 4313. After that, the ball portion 411 is situated within the first room 4312 and contacts the bearing socket 42. The restriction unit 44 is then situated within the interior of the cap body 431 and contacts the bearing socket 42 so that the second engagement portion 452 of the restriction unit 44 is engaged with the first engagement portion 451 of the bearing socket 42, thereby achieving a tight engagement between the restriction unit 44 and the bearing socket 42 to allow the ball portion 411 to be confined by the restriction unit 44 and closely abut against the bearing socket 42. Thus, the ball portion 411 is positioned properly and capable of being rotated within the first room 4312. In this preferred embodiment, the second engagement portion 452 is protruded from an outer periphery of the restriction unit 44. The first engagement portion 451 is recessed into an outer periphery of the bearing socket 42. The first engagement portion 451 and the second engagement portion 452 are situated relative to each other. Thus, the engagement of the first engagement portion 451 and the second engagement portion 452 prevents the displacement or deviation of the restriction unit 44 while operating the ball portion 411, thereby preventing the restriction unit 44 from rubbing against the cap body 431.

The bearing socket 42 is made of a metal material, thereby increasing the strength of the bearing socket 42 and preventing the improper worn of the bearing socket 42. The elastic unit 46 is then situated on a top of the restriction unit 44 within the interior of the cap body 431, and thence the fastening portion 471 of the cover unit 47 is situated on a top of the elastic unit 46 within the interior of the cap body 431. The fastening portion 471 is pressed by the bending portion 432 of the base cap 43, thereby completing the installation of the suspension ball joint 4. The elasticity of the elastic unit 46 prevents the restriction unit 44 from being improperly pressed by the fastening portion 471 of the cover unit 47 when the fastening portion 471 is pressed by the bending portion 432 of the base cap 43, and that prevents the ball portion 411 from improperly rubbing against the bearing socket 42 because the restriction unit 44 will not press the ball portion 411 unduly. Hence, the pressing forces applied on the ball portion 411 and the bearing socket 42 are reduced, thereby extending the service life of the bearing socket 42. Meanwhile, the lubricating liquid accommodated in the second room 4313 is delivered to the bearing socket 42, thereby achieving the lubrication effect between the ball portion 411 and the bearing socket 42. Further, the thickness of the cap body 431 is enlarged when the second room 4313 is disposed, and thus the cap body 431 with the increased thickness can bear the pressing forces caused by the operation of the ball portion 411. Thus, the service life and the durability of the suspension ball joint 4 are improved.

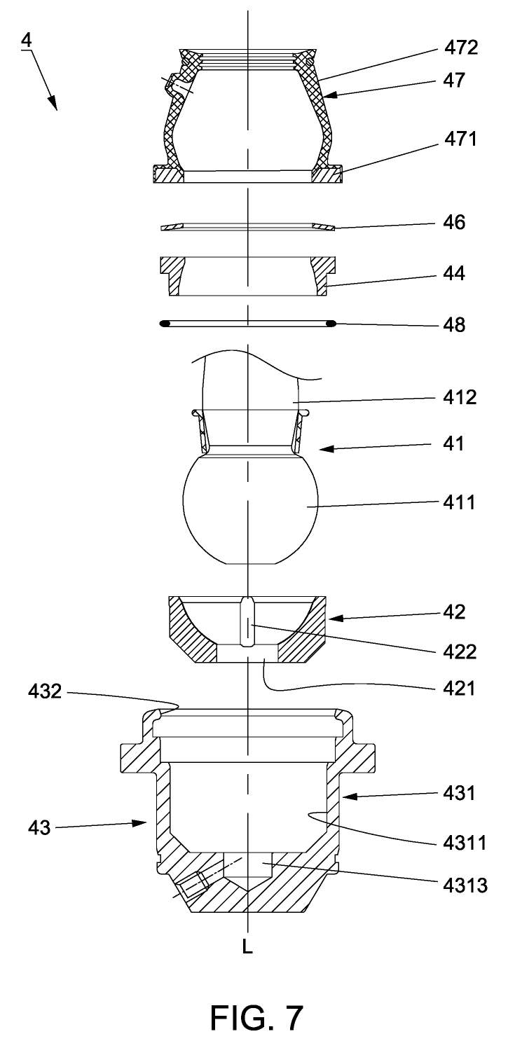

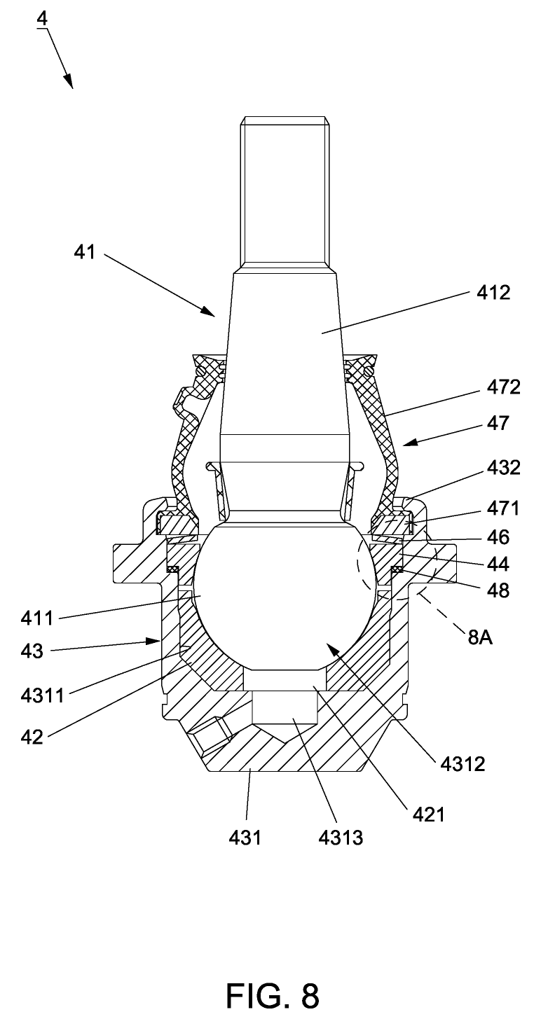

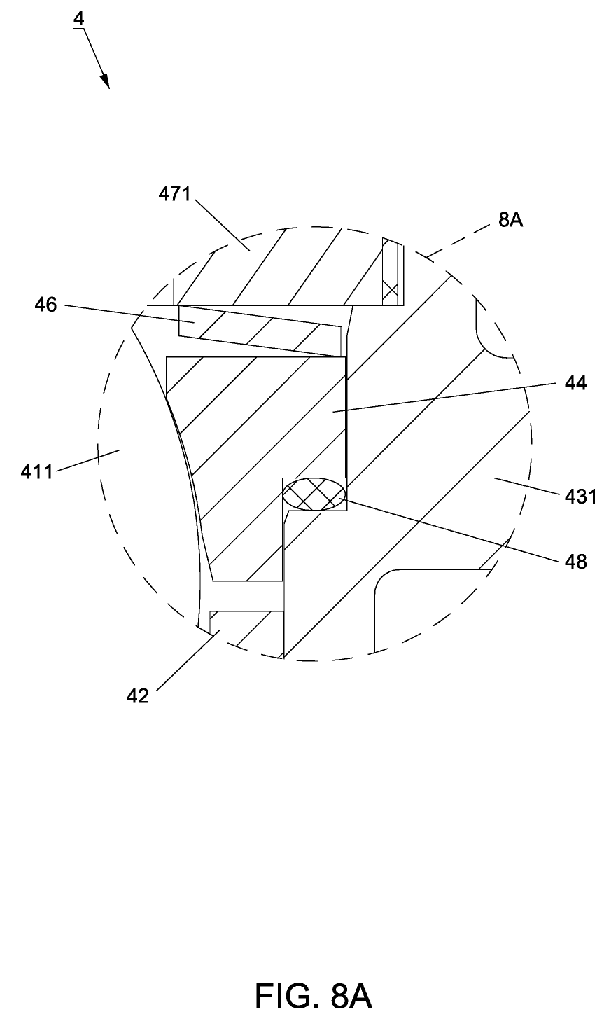

Referring to FIGS. 7, 8 and 8A show a second preferred embodiment of the suspension ball joint 4 of this invention still comprising the ball stud 41, the bearing socket 42, the base cap 43, the restriction unit 44, the elastic unit 46, and the cover unit 47. The correlated elements and the concatenation of elements, the operation and objectives of the second preferred embodiment are the same as those of the first preferred embodiment. This embodiment is characterized in that an anti-skid gasket 48 is installed between the restriction unit 44 and the cap body 431 of the base cap 43. The frictional resistance of the anti-skid gasket 48 assists in preventing the displacement or deviation of the restriction unit 44. Thus, the restriction unit 44 will not rub against the cap body 431 improperly, thereby extending the service life and improving the durability of the suspension ball joint 4.

To sum up, the suspension ball joint of this invention takes advantages that the bearing socket is make of a metal material and engaged with the cap body of the base cap in a tight fit manner, thereby increasing the strength and preventing the bearing socket from rubbing against the base cap while operating the ball portion of the ball stud. The engagement unit or the anti-skid gasket is adapted to prevent the displacement or deviation of the restriction unit, thereby preventing the restriction unit from rubbing against the cap body of the base cap. Thus, the bearing socket and the restriction unit will not be worn improperly. The elastic unit prevents the restriction unit from being pressed improperly by the cover unit and the base cap, thereby reducing the pressing forces applied on the ball portion caused by the restriction unit. Hence, the ball portion will not rub against the bearing socket improperly because the restriction unit will not press the ball portion unduly. Therefore, the service life and the durability of the suspension ball joint are improved.

While the embodiments of this invention are shown and described, it is understood that further variations and modifications may be made without departing from the scope of this invention.

What is claimed is:

1. A suspension ball joint comprising:
a ball stud including a ball portion and a stud portion extending outwards from said ball portion;
a bearing socket made of a metal material and including a socket opening and at least one socket trough communicating with said socket opening;
a base cap including a cap body whose interior is enclosed by an inner cap wall, said base cap further including a bending portion situated on a top edge of said cap body, wherein said interior of said cap body defines a central axis, said bending portion extending toward said central axis, said bearing socket being arranged and accommodated within said interior of said cap body, with said bearing socket engaged with said inner cap wall in a tight fit manner, the arrangement of said bearing socket dividing said interior of said cap body into a first room adapted to accommodate said ball portion of said ball stud and a second room adapted to accommodate lubricating liquid, said socket opening communicating with said first room and said second room respectively;
a restriction unit disposed within said interior of said cap body and located on a top of said bearing socket;
an engagement unit respectively disposed on said bearing socket and said restriction unit so that said bearing socket is engaged with said restriction unit by said engagement unit;
an elastic unit disposed within said interior of said cap body and located on a top of said restriction unit; and
a cover unit including a fastening portion disposed within said interior of said cap body and a surrounding portion extending outwards from said fastening portion, said fastening portion being located on a top of said elastic unit, said stud portion of said ball stud penetrating through said surrounding portion to allow a portion of said stud portion to be exposed outside said surrounding portion, wherein said fastening portion, said elastic unit, and said restriction unit are sequentially arranged between said stud portion and said bearing socket after said bearing socket and said ball portion of said ball stud are situated in said cap body, with said fastening portion of said cover unit pressed by said bending portion so that said elastic unit and said restriction unit are densely placed in position within said interior of said cap body, thereby allowing said restriction unit to confine said ball portion within said first room.

2. The suspension ball joint according to claim 1, wherein said suspension ball joint is adapted to be used in a vehicle suspension system.

3. The suspension ball joint according to claim 1, wherein said engagement unit includes a first engagement portion disposed on said bearing socket and a second engagement portion disposed on said restriction unit, said first engagement portion being snugly engaged with said second engagement portion.

4. A suspension ball joint comprising:
a ball stud including a ball portion and a stud portion extending outwards from said ball portion;
a bearing socket made of a metal material and including a socket opening and at least one socket trough communicating with said socket opening;
a base cap including a cap body whose interior is enclosed by an inner cap wall, said base cap further including a bending portion situated on a top edge of said cap body, wherein said interior of said cap body defines a central axis, said bending portion extending toward said central axis, said bearing socket being arranged and accommodated within said interior of said cap body, with said bearing socket engaged with said inner cap wall in a tight fit manner, the arrangement of said bearing socket dividing said interior of said cap body into a first room adapted to accommodate said ball portion of said ball stud and a second room adapted to accommodate lubricating liquid, said socket opening communicating with said first room and said second room respectively;
a restriction unit disposed within said interior of said cap body and located on a top of said bearing socket;
an anti-skid gasket disposed between said restriction unit and said cap body of said base cap;
an elastic unit disposed within said interior of said cap body and located on a top of said restriction unit; and
a cover unit including a fastening portion disposed within said interior of said cap body and a surrounding portion extending outwards from said fastening portion, said fastening portion being located on a top of said elastic unit, said stud portion of said ball stud penetrating through said surrounding portion to allow a portion of said stud portion to be exposed outside said surrounding portion, wherein said fastening portion, said elastic unit, and said restriction unit are sequentially arranged between said stud portion and said bearing socket after said bearing socket and said ball portion of said ball stud are situated in said cap body, with said fastening portion of said cover unit pressed by said bending portion so that said elastic unit and said restriction unit are densely placed in position within said interior of said cap body, thereby allowing said restriction unit to confine said ball portion within said first room.

5. The suspension ball joint according to claim 4, wherein said suspension ball joint is adapted to be used in a vehicle suspension system.
